(19) United States
(12) Patent Application Publication
(10) Pub. No.: US 2025/0184284 A1
(43) Pub. Date: Jun. 5, 2025

(54) COMMUNICATION SYSTEM, COMMUNICATION METHOD, ANDCOMMUNICATION PROGRAM

(71) Applicant: NIPPON TELEGRAPH AND TELEPHONE CORPORATION, Tokyo (JP)

(72) Inventors: Yuki MIYOSHI, Tokyo (JP); Akinori FURUTA, Tokyo (JP); Yuhei HAYASHI, Tokyo (JP); Atsushi SUTO, Tokyo (JP); Chiharu MORIOKA, Tokyo (JP); Masato YAMADA, Tokyo (JP); Satomi INOUE, Tokyo (JP)

(73) Assignee: NIPPON TELEGRAPH AND TELEPHONE CORPORATION, Tokyo (JP)

(21) Appl. No.: 18/839,421

(22) PCT Filed: Feb. 22, 2022
(86) PCT No.: PCT/JP2022/007376

§ 371 Date: Aug. 17, 2024

(51) Int. Cl. H04L 47/80; H04L 43/02; H04L 43/0894

(52) U.S. Cl. CPC H04L 47/80; H04L 43/02; H04L 43/0894

(57) ABSTRACT

Provided is a communication system including a flow collector (40) that collects traffic information of a network constructed by a plurality of network devices (10-1 to 10-3); a flow exporter (30) that transmits traffic information transmitted from the plurality of network devices (10-1 to 10-3) to the flow collector (40); external devices (20-1 to 20-3), each of which is provided for each of the network devices (10-1 to 10-3), receives traffic information from each of the network devices (10-1 to 10-3), and controls transmission of the received traffic information to the flow exporter (30); and a controller (50) that selects the network device from which the traffic information is not collected based on regularity of the network, and causes the external device corresponding to the selected network device to stop transmitting the traffic information to the flow exporter (30).

### TECHNICAL FIELD

The present invention relates to a communication system, a communication method, and a communication program.

### BACKGROUND ART

For network management, statistical information of traffic flowing through a network is collected to identify loads of lines and networks, to investigate a cause of communication failure, and to detect attacks.

Conventionally, NetFlow has been proposed as a method for sending statistical information of each flow (see Non Patent Literature 1).

### CITATION LIST

### Non Patent Literature

Non Patent Literature 1: “RFC 3954”, [online], [retrieved on Jan. 24, 2022], Internet <URL: https://datatracker.ietf.org/doc/html/rfc3954.html>

### SUMMARY OF INVENTION

### Technical Problem

A communication route to a traffic information collection system is not sufficient for large-scale, complicated carrier networks. Hence, a bandwidth of a monitoring network for collecting traffic information may be difficult to secure, and the traffic information collection system may not be able to flexibly address a sudden increase in traffic.

The present invention has been made in view of the above, and an object thereof is to provide a communication system, a communication method, and a communication program, each capable of appropriately collecting traffic information.

### Solution to Problem

In order to solve the problems above and achieve the object, a communication system according to the present invention is a communication system including: a collection device that collects traffic information of a network constructed by a plurality of network devices; a transmission device that transmits traffic information transmitted from the plurality of network devices to the collection device; a transmission control device that is provided for each network device, receives traffic information from the network device, and controls transmission of the received traffic information to the transmission device; and a control device that selects the network device from which the traffic information is not collected based on regularity of the network, and causes the transmission control device corresponding to the selected network device to stop transmitting the traffic information to the transmission device.

### Advantageous Effects of Invention

According to the present invention, it is possible to appropriately collect traffic information.

### BRIEF DESCRIPTION OF DRAWINGS

FIG. 1 is a block diagram illustrating one example of a configuration of a communication system according to an embodiment.

FIG. 2 is a diagram illustrating an outline of communication processing according to the embodiment.

FIG. 3 is a diagram illustrating an outline of communication processing according to the embodiment.

FIG. 4 is a diagram schematically illustrating one example of a configuration of a controller.

FIG. 5 is a flowchart illustrating a processing procedure of non-verbal feature value extraction processing illustrated in FIG. 2.

FIG. 6 is a sequence diagram illustrating one example of a processing procedure of communication processing according to the embodiment.

FIG. 7 is a sequence diagram illustrating one example of the processing procedure of communication processing according to the embodiment.

FIG. 8 is a diagram illustrating a conventional traffic information system and a monitored network.

FIG. 9 is a diagram illustrating a conventional traffic information system and a monitored network.

FIG. 10 is a diagram illustrating one example of a computer in which a program is executed and thus a network device, an external device, a flow exporter and a controller are implemented.

### DESCRIPTION OF EMBODIMENTS

Hereinafter, an embodiment of the present invention will be described in detail with reference to the drawings. Note that the present invention is not limited by this embodiment. Further, in the description of the drawings, the same reference signs are assigned to the same components.

### EMBODIMENT

Embodiments will be described hereinbelow. In an embodiment, a communication system that collects traffic information for a network to be monitored using telemetry will be described.

### [Configuration of Communication System]

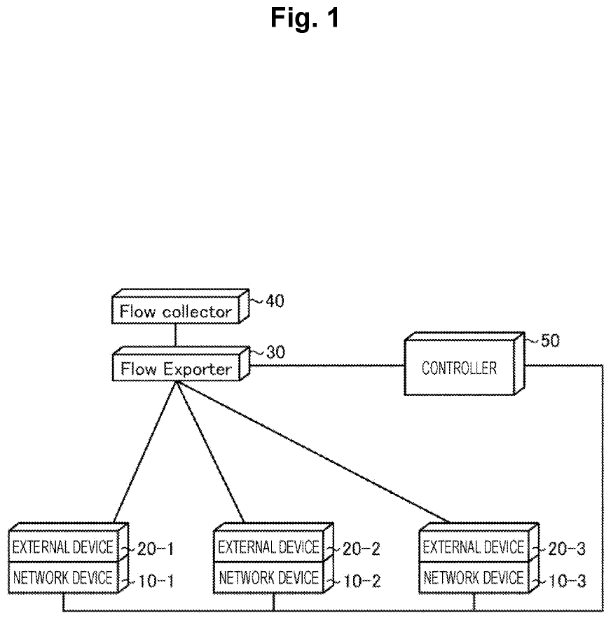

A configuration of a communication system according to an embodiment will be described. FIG. 1 is a block diagram illustrating one example of the configuration of the communication system according to the embodiment.

As illustrated in FIG. 1, the communication system according to the embodiment includes a flow collector 40 (collection device) that collects traffic information of a network constructed by a plurality of network (NW) devices 10-1 to 10-3, and a flow exporter 30 (transmission device) that transmits the traffic information transmitted from the plurality of network devices 10-1 to 10-3 to the flow collector 40. The network devices 10-1 to 10-3 are, for example, routers.

In the communication system according to the embodiment, external devices 20-1 to 20-3 (transmission control devices) are provided for the network devices 10-1 to 10-3, respectively. The communication system according to the embodiment further includes a controller 50 (control device). The configuration illustrated in FIG. 1 is merely an example, and a specific configuration and the number of devices are not particularly limited. The network devices 10-1 to 10-3 may be collectively referred to as the network device 10. The external devices 20-1 to 20-3 may be collectively referred to as the external device 20.

The external devices 20-1 to 20-3 receive traffic information from the corresponding network devices 10-1 to 10-3, respectively, and control transmission of the received traffic information to the flow exporter 30.

The controller 50 establishes communications with the network devices 10-1 to 10-3, the external devices 20-1 to 20-3, and the flow exporter 30. The controller 50 selects the network device 10 from which traffic information is not collected based on network regularity.

The controller 50 causes the external device 20 corresponding to the selected network device 10 to stop transmission of traffic information to the flow exporter 30.

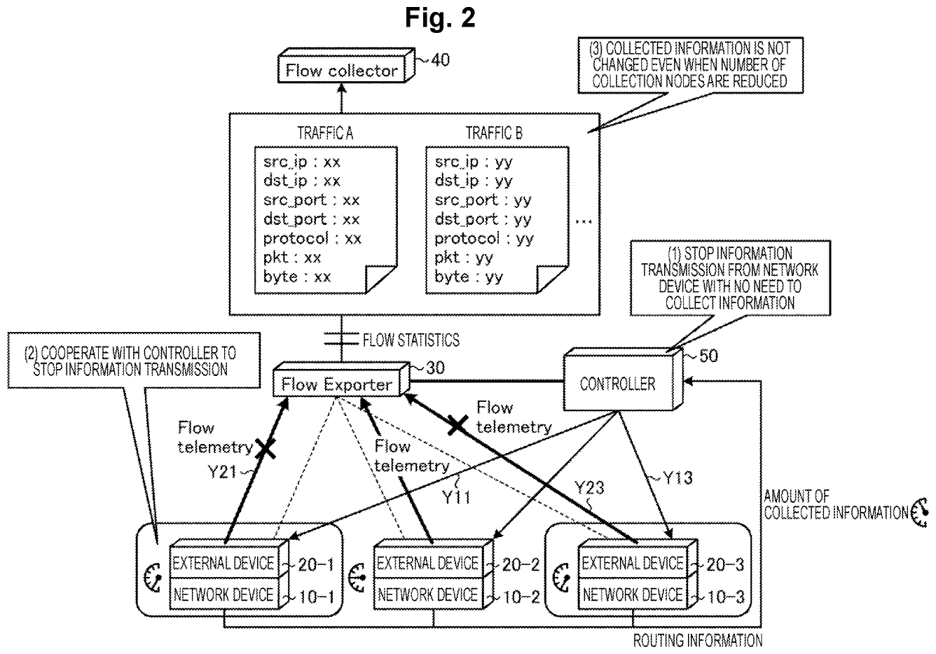

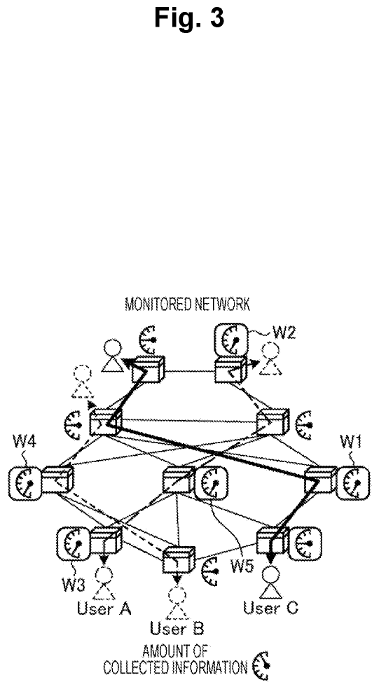

FIGS. 2 and 3 are diagrams each illustrating an outline of communication processing according to the embodiment. As illustrated in FIG. 2, the controller 50 collects topology information and routing information included in a routing protocol from the network devices 10-1 to 10-3, and determines network regularity in advance. Based on the network regularity, the controller 50 determines the network device 10 having a high need to collect traffic information and the network device 10 having a low need to collect traffic information. The controller 50 selects the network device 10 having a low need to collect traffic information as the network device 10 from which traffic information is not collected, and stops transmission of the traffic information from the selected network device 10 ((1) in FIG. 2).

For example, the controller 50 stops the transmission of the traffic information from the network devices 10-1 and 10-3. Specifically, the controller 50 causes the external devices 20-1 and 20-3 corresponding to the network devices 10-1 and 10-3, respectively, to stop transmission of traffic information to the flow exporter 30 (denoted by arrows Y11 and Y13).

The external devices 20-1 and 20-3 stop transmission of the traffic information received from the corresponding network devices 10-1 and 10-3 to the flow exporter 30 in accordance with a transmission stop command issued by the controller 50 (denoted by arrows Y21 and Y23). The external devices 20-1 and 20-3 cooperate with the controller 50 and transmit the traffic information to the flow exporter 30 ((2) in FIG. 2).

As described above, in the communication system according to the embodiment, collection of traffic information from network device having a low need to collect is stopped (see frames W1 to W5 in FIG. 3), and a bandwidth reduction is enabled for the monitoring symmetric network.

In other words, in the communication system according to the embodiment, it is possible to reduce a communication load of the flow exporter 30 by reducing the number (collection nodes) of the network devices 10 from which traffic information is collected. Further, in the communication device according to the embodiment, the communication load of the flow exporter 30 is reduced, whereby no information is omitted even when bandwidth overflow occurs due to sudden traffic increase, and thus maximum information collection is enabled. Since collected information is the same even if the number of collection nodes is reduced, it is possible to appropriately collect the traffic information ((3) in FIG. 2).

### [Controller]

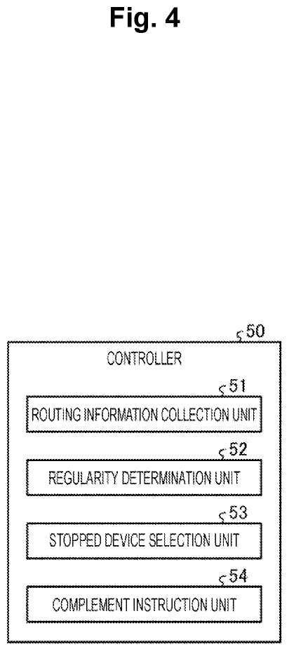

The controller 50 illustrated in FIG. 1 will be described. FIG. 4 is a diagram schematically illustrating one example of a configuration of the controller 50.

The controller 50 is implemented by, for example, a predetermined program being read by, for example, a computer including a read only memory (ROM), a random access memory (RAM), and a central processing unit (CPU), while the CPU executes the predetermined program. Further, the controller 50 includes a communication interface that transmits and receives various types of information to and from another device connected via, for example, a network.

The controller 50 includes a routing information collection unit 51, a regularity determination unit 52, a stopped device selection unit 53, and a complement instruction unit 54.

The routing information collection unit 51 collects topology information and routing information included in the routing protocol from each network device 10. The topology information is information indicating a connection between devices on the network. The routing information is information recorded in the network device 10, which indicates a transfer route of data.

The regularity determination unit 52 determines the network regularity on the basis of the collected topology information and routing information. For example, the regularity determination unit 52 determines the symmetry of the network.

The stopped device selection unit 53 selects the network device 10 from which traffic information is not collected based on the network regularity, and causes the external device 20 corresponding to the selected network device 10 to stop transmission of traffic information to the flow exporter 30. In a case where the network is symmetric, the stopped device selection unit 53 selects one network device 10 out of the pair of symmetric network devices 10 as the network device from which traffic information is not collected.

The complement instruction unit 54 causes the flow exporter 30 to complement traffic information as if the traffic information were acquired from the network device 10 from which traffic information is not collected. The complement instruction unit 54 causes the flow exporter 30 to complement the traffic information from one network device 10 from which traffic information is collected, out of the pair of symmetric network devices 10, based on the traffic information from the other network device 10.

### Application Example

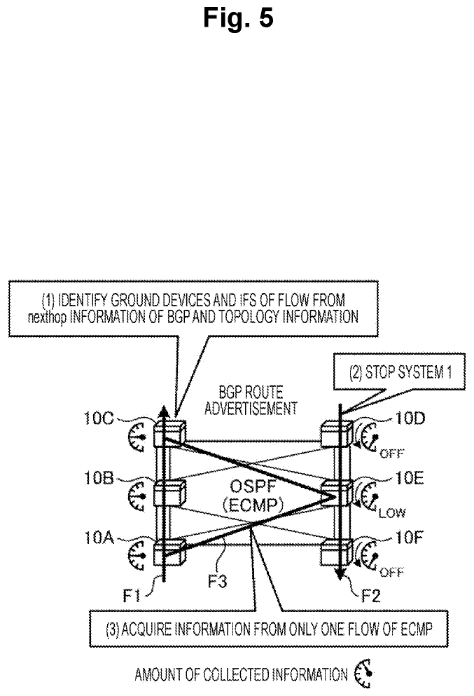

FIG. 5 is a diagram illustrating an application example of the embodiment. For example, a network in which the routing protocol is a border gateway protocol (BGP) will be described.

The controller 50 collects routing information from network devices 10A to 10F on the network. The controller 50 identifies ground devices and interfaces (IFs) (connection function) of a flow from nexthop information of BGP and the topology information ((1) in FIG. 5).

For example, the controller 50 determines that the network has a ladder configuration, and systems 0 and 1 are set. The controller 50 determines a system 0 flow (for example, flow F1) and a system 1 flow (for example, flow F2) symmetrical to the system 0 based on the grounds devices and IFs of the flow.

The controller 50 stops collection of traffic information from network devices 10D, 10E, and 10F on a system 1 flow F3 ((2) in FIG. 5). The controller 50 commands the external devices 20 respectively provided for the network devices 10D, 10E and 10F to stop transmission of traffic information to the flow exporter 30.

The controller 50 complements the flow exporter 30 as if the traffic information is acquired in the network devices 10D, 10E, and 10F for which traffic information collection has been stopped. The flow exporter 30 complements the traffic information based on, for example, the traffic information collected from the network devices 10A to 10C on the flow F1.

A case will be described in which the controller 50 determines that there is a route F2 passing through the network device 10E at the middle of the system 1 by one traffic from path weighting by application of Equal Cost Multi Path (ECMP). In this case, for a route F3, the controller 50 collects traffic information from the network device 10E only for one flow of ECMP ((3) in FIG. 5) and complements the traffic information of the flow F1. The controller 50 appropriately performs regularity determination and stop setting for traffic information according to the network status.

### [Communication Processing]

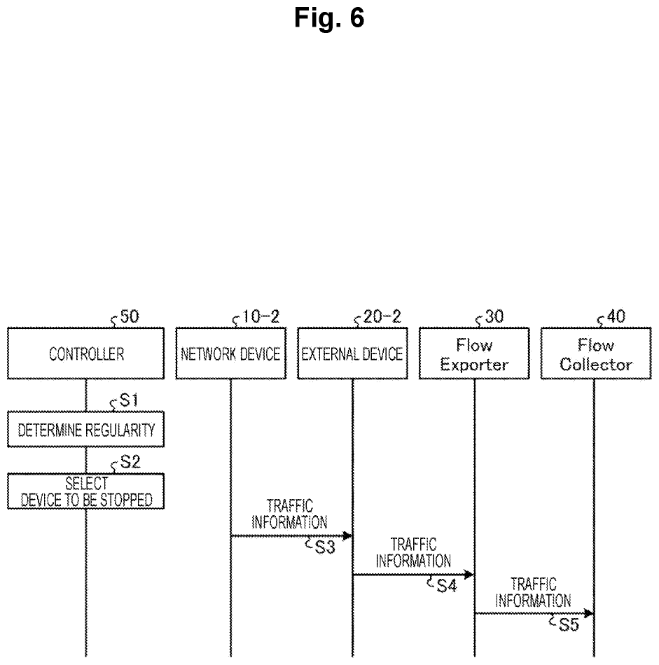

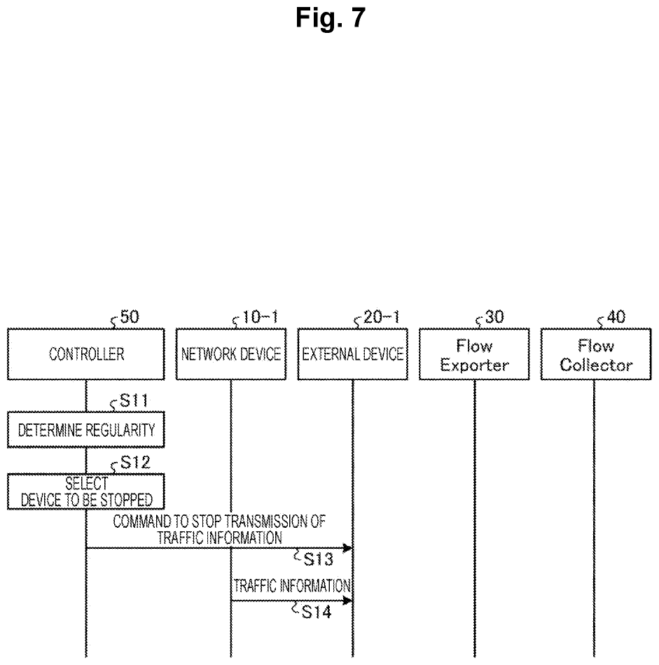

A processing procedure of communication processing according to the embodiment will be described. FIGS. 6 and 7 are sequence diagrams each illustrating one example of a processing procedure of communication processing according to the embodiment.

As illustrate in FIGS. 6 ad 7, the controller 50 collects topology information and routing information included in a routing protocol from the network device 10-2, and determines the network regularity in advance (steps S1 and S11). The controller 50 selects the network device 10 from which traffic information is not collected based on the network regularity (steps S2 and S12).

In the case of the example shown in FIG. 6, the controller 50 selects the network device 10-2 as the network device from which traffic information is collected. Therefore, the controller 50 does not stop transmission of traffic information for the network device 10-2. Accordingly, the traffic information transmitted from the network device 10-2 is transmitted from the external device 20-2 to the flow exporter 30 (steps S3 and S4). The flow exporter 30 transmits the traffic information transmitted from the external device 20-2 to the flow collector 40 (step S5).

On the other hand, in the case of the example shown in FIG. 7, the controller 50 selects the network device 10-1 as the network device from which traffic information is not collected, and stops transmission of traffic information. In this case, the controller 50 commands the external device 20-1 provided for the network device 10-1 to stop transmission of traffic information to the flow exporter 30 (step S13). Even if the external device 20-1 receives the traffic information transmitted from the network device 10-2 (step S14), the received traffic information is not transmitted to the flow exporter 30.

### Effects of Embodiment

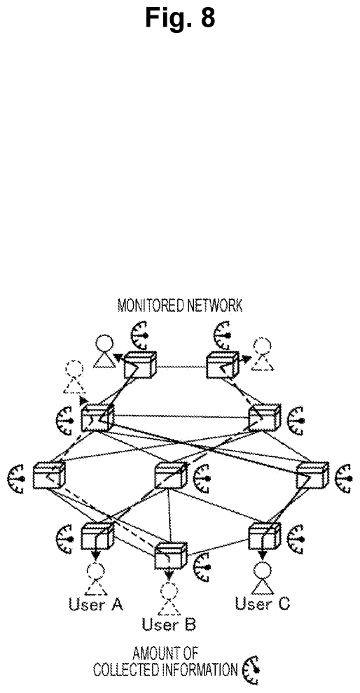

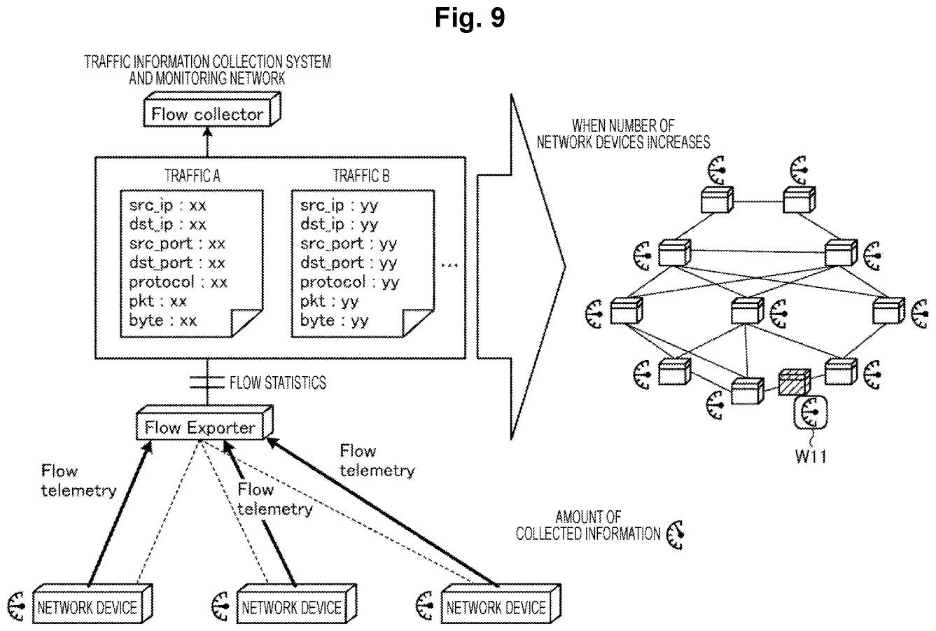

FIGS. 8 and 9 are diagrams each illustrating a conventional traffic information system and a monitored network. Conventionally, as illustrated in FIGS. 8 and 9, when monitoring traffic increases (see frame W11 in FIG. 9), the amount of information to be collected similarly increases, leading to band compression of the monitoring network. Hence, a bandwidth of a monitoring network for collecting traffic information may be difficult to secure, and the traffic information collection system may not be able to flexibly address a sudden increase in traffic.

On the other hand, in the embodiment, the controller 50 determines the network regularity on the basis of the routing information collected from the network device 10, and selects the network device 10 from which traffic information is not collected.

That is, in the embodiment, it is possible to reduce a communication load of the flow exporter 30 by reducing the number (collection nodes) of the network devices 10 from which traffic information is collected. Further, in the embodiment, the communication load of the flow exporter 30 is reduced, whereby no information is omitted even when bandwidth overflow occurs due to sudden traffic increase, and thus efficient and appropriate collection of traffic information is enabled, flexibly corresponding to the sudden traffic increase.

### [System Configuration of Embodiment]

Each component (network device 10, external device 20, flow exporter 30 and controller 50) is functionally conceptual, and does not necessarily have to be physically configured as illustrated in the drawings. That is, specific forms of distribution and integration of the functions of the network device 10, the external device 20, the flow exporter 30 and the controller 50 are not limited to the illustrated forms, and all or a part thereof can be functionally or physically distributed or integrated in any unit according to for example, various loads and usage conditions.

Furthermore, all or any part of the processing performed in the network device 10, the external device 20, the flow exporter 30 and the controller 50 may be implemented by a CPU, a graphics processing unit (GPU), and a program analyzed and executed by the CPU and the GPU. Moreover, each piece of processing performed in the network device 10, the external device 20, the flow exporter 30 and the controller 50 may be implemented as hardware by wired logic.

Moreover, among the pieces of processing described in the embodiment, all or a part of the processing described as being automatically performed can be manually performed. Alternatively, all or a part of the processing described as being manually performed can be automatically performed by a known method. In addition, the above-described and illustrated processing procedures, control procedures, specific names, and information including various data and parameters can be appropriately changed unless otherwise specified.

### [Program]

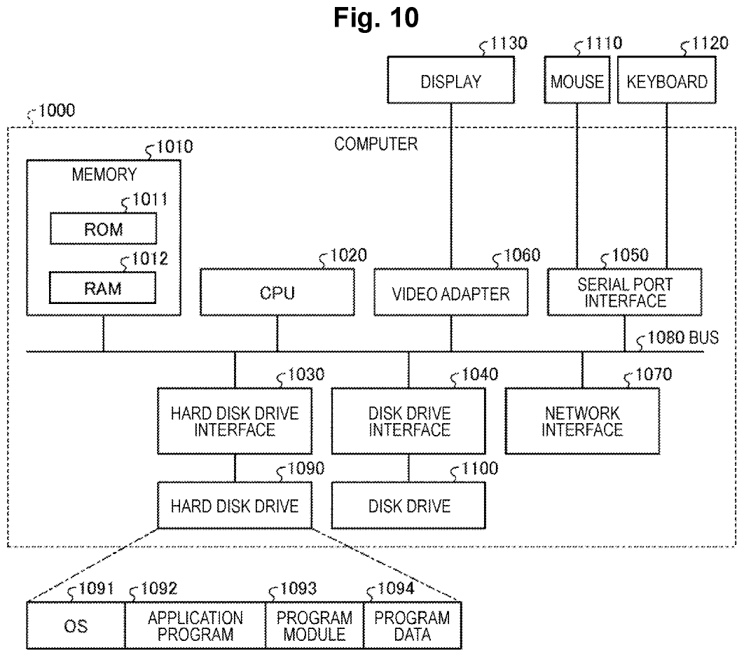

FIG. 10 is a diagram illustrating one example of a computer in which a program is executed and thus the network device 10, the external device 20, the flow exporter 30 and the controller 50 are implemented. A computer 1000 includes a memory 1010 and a CPU 1020, for example. Moreover, the computer 1000 also includes a hard disk drive interface 1030, a disk drive interface 1040, a serial port interface 1050, a video adapter 1060, and a network interface 1070. These units are connected to each other by a bus 1080.

The memory 1010 includes a ROM 1011 and a RAM 1012. The ROM 1011 stores, for example, a boot program such as a basic input output system (BIOS). The hard disk drive interface 1030 is connected with a hard disk drive 1090. The disk drive interface 1040 is connected with a disk drive 1100. For example, a removable storage medium such as a magnetic disk or an optical disk is inserted into the disk drive 1100. The serial port interface 1050 is connected with, for example, a mouse 1110 and a keyboard 1120. The video adapter 1060 is connected with, for example, a display 1130.

The hard disk drive 1090 stores, for example, an operating system (OS) 1091, an application program 1092, a program module 1093, and program data 1094. That is, a program that defines each piece of processing of the network device 10, the external device 20, the flow exporter 30 and the controller 50 is implemented as the program module 1093 in which a code executable by the computer 1000 is described. The program module 1093 is stored in, for example, the hard disk drive 1090. For example, the program module 1093 for executing processing similar to the functional configurations in the network device 10, the external device 20, the flow exporter 30 and the controller 50 is stored in the hard disk drive 1090. Note that the hard disk drive 1090 may be replaced with a solid state drive (SSD).

Moreover, setting data used in the processing of the above-described embodiment is stored as the program data 1094 in, for example, the memory 1010 or the hard disk drive 1090. The CPU 1020 reads the program module 1093 and the program data 1094 stored in the memory 1010 and the hard disk drive 1090 into the RAM 1012 as necessary and executes the program module 1093 and the program data 1094.

Note that the program module 1093 and the program data 1094 are not limited to being stored in the hard disk drive 1090, and may be stored in, for example, a removable storage medium and read by the CPU 1020 via, for example, the disk drive 1100. Alternatively, the program module 1093 and the program data 1094 may be stored in another computer connected via a network (for example, local area network (LAN) or wide area network (WAN)). Then, the program module 1093 and the program data 1094 may be read by the CPU 1020 from another computer via the network interface 1070.

Although the embodiment to which the invention made by the present inventors is applied has been described above, the present invention is not limited by the description and drawings constituting a part of the disclosure of the present invention according to the present embodiment. That is, other embodiments, examples and operations made by those skilled in the art based on the present embodiment are all encompassed in the scope of the present invention.

### REFERENCE SIGNS LIST

10, 10-1 to 10-3, 10A to 10F Network device
20, 20-1 to 20-3 External device
30 Flow exporter
40 Flow collector
50 Controller
51 Routing information collection unit
52 Regularity determination unit
53 Stopped device selection unit
54 Complement instruction unit

1. A communication system comprising a processor configured to execute operations comprising:
transmitting, by a first device, traffic information, wherein the traffic information is previously received by the first device from a second device of a plurality of second devices over a network;
collecting, by a third device, the transmitted traffic information of the network;
receiving, by a fourth device associated with the second device of the plurality of second devices, the traffic information from the second device, and preventing transmission of the received traffic information to the first device;
selecting, by a fifth device, the second device for preventing collection of the traffic information from the second device according to regularity of the network; and
stopping the fourth device corresponding to the selected second device from transmitting the traffic information to the first device.

2. The communication system according to claim 1,
wherein the fifth device comprises a processor configured to execute operations comprising:
collecting routing information that indicates a data transfer route from each second device of the plurality of second devices;
determining regularity of the network based on the routing information;
selecting the second device for preventing collection of the traffic information from the second device according to the regularity of the network; and
causing the fourth device corresponding to the selected second device to stop transmitting the traffic information to the first device.

3. The communication system according to claim 2, wherein the selecting further comprises selecting, in a case where the network is symmetric, one network from a pair of symmetrical second devices as a second device for preventing collection of the traffic information from the second device.

4. A method comprising:
transmitting, by a first device, traffic information, wherein the traffic information is previously received by the first device from a second device of a plurality of second devices over a network;
collecting, by a third device, the transmitted traffic information of the network;
receiving, by a fourth device associated with the second device of the plurality of second devices, traffic information from each corresponding second device of the plurality of second devices, and prevents transmission of the received traffic information to the first device; and
selecting, by a fifth device, the second device for preventing collection of the traffic information from the second device according to regularity of the network; and
stopping the fourth device corresponding to the selected network device from transmitting the traffic information to the first device.

5. A computer-readable non-transitory recording medium storing a computer-executable program instructions that when executed by a processor cause a computer to execute operations comprising:
transmitting, by a first device, traffic information, wherein the traffic information is previously received by the first device from a second device of a plurality of second devices over a network;
collecting, by a third device, the transmitted traffic information of the network;
receiving, by a fourth device associated with the second device of the plurality of second devices, the traffic information from each corresponding second device of the plurality of second devices, and preventing transmission of the received traffic information to the first device;
selecting, by a fifth device, the second device for preventing collection of the traffic information from the second device according to regularity of the network; and
stopping the fourth device corresponding to the selected second device from transmitting the traffic information to the first device.

6. The communication system according to claim 1,
wherein the first device represents a transmission device,
the second device represents a network device,
the third device represents a collection device,
the fourth device represents a transmission control device, and
the fifth device represents a control device.

7. The communication system according to claim 6,
wherein the transmission device attaches to the network device,
the collection device collects the traffic information from the transmission device, and
the control device, based on the regularity of selects the network device for stopping collection of the traffic information from the network device,
the control device causes the transmission control device to instruct the transmission device attached to the network device to stop transmitting the traffic information, and
the transmission control device causes the transmission device to stop transmitting the traffic information.

8. The communication system according to claim 1, wherein the regularity of the network is based on routing information of the network.

9. The communication system according to claim 1, wherein the regularity of the network is based on a symmetry of a configuration of the network.

10. The method according to claim 4,
wherein the first device represents a transmission device,
the second device represents a network device,
the third device represents a collection device,
the fourth device represents a transmission control device, and
the fifth device represents a control device.

11. The method according to claim 10,
wherein the transmission device attaches to the network device,
the collection device collects the traffic information from the transmission device, and
the control device, based on the regularity of selects the network device for stopping collection of the traffic information from the network device,
the control device causes the transmission control device to instruct the transmission device attached to the network device to stop transmitting the traffic information, and
the transmission control device causes the transmission device to stop transmitting the traffic information.

12. The method according to claim 4, wherein the regularity of the network is based on routing information of the network.

13. The method according to claim 4, wherein the regularity of the network is based on a symmetry of a configuration of the network.

14. The method according to claim 4,
wherein the fifth device comprises a processor configured to execute operations comprising:
collecting routing information that indicates a data transfer route from each second device of the plurality of second devices;
determining regularity of the network based on the routing information;
selecting the second device for preventing collection of the traffic information from the second device according to the regularity of the network; and
causing the fourth device corresponding to the selected second device to stop transmitting the traffic information to the first device.

15. The method according to claim 14, wherein the selecting further comprises selecting, in a case where the network is symmetric, one network from a pair of symmetrical second devices as a second device for preventing collection of the traffic information from the second device.

16. The computer-readable non-transitory recording medium according to claim 5, wherein the regularity of the network is based on routing information of the network.

17. The computer-readable non-transitory recording medium according to claim 5, wherein the regularity of the network is based on a symmetry of a configuration of the network.

18. The computer-readable non-transitory recording medium according to claim 5, wherein the fifth device comprises a processor configured to execute operations comprising:
collecting routing information that indicates a data transfer route from each second device of the plurality of second devices;
determining regularity of the network based on the routing information;
selecting the second device for preventing collection of the traffic information from the second device according to the regularity of the network; and
causing the fourth device corresponding to the selected second device to stop transmitting the traffic information to the first device.

19. The computer-readable non-transitory recording medium according to claim 18, wherein the selecting further comprises selecting, in a case where the network is symmetric, one network from a pair of symmetrical second devices as a second device for preventing collection of the traffic information from the second device.

20. The computer-readable non-transitory recording medium according to claim 18,
wherein the first device represents a transmission device,
the second device represents a network device,
the third device represents a collection device,
the fourth device represents a transmission control device, and
the fifth device represents a control device.
